(19) United States
(12) Patent Application Publication
(10) Pub. No.: US 2013/0284627 A1
(43) Pub. Date: Oct. 31, 2013

(54) TOOL HOLDER

(71) Applicant: WAGIC, INC., Los Gatos, CA (US)

(72) Inventors: Ronald L. Johnson, San Jose, CA (US); Robert J. Gallegos, Fremont, CA (US); Steven Simas Escobar, San Jose, CA (US); Anders Scot Hudson, Campbell, CA (US); Idriss Mansouri-Chafik Ruiz, San Jose, CA (US); Yugen Patrick Lockhart, Palo Alto, CA (US); Howard Allen Wilson, Santa Clara, CA (US); Eric M. Colton, Torrance, CA (US)

(21) Appl. No.: 13/932,780

(22) Filed: Jul. 1, 2013

Related U.S. Application Data
(62) Division of application No. 12/009,532, filed on Jan. 17, 2008, now Pat. No. 8,499,667.

(51) Int. Cl. B25H 3/02; B25G 3/02

(52) U.S. Cl. CPC B25H 3/022; B25H 3/02; B25G 3/02
USPC 206/375; 206/372; 53/473; 81/489

(57) ABSTRACT

A tool handle includes a cavity to receive a T-handle tool. When the tool handle is placed on the T-handle tool, the tool handle provides a better grip of the tool handle to apply greater torque. The tool handle includes a protrusion which is able to detachably couple with the T-handle tool. Once coupled with the T-handle tool, the tool handle is able to be grasped by a user to rapidly turn the T-handle tool. In some embodiments, the T-handle tool includes an added tool. A tool container is able to store T-handle tools and the tool handle. The tool container includes a locking mechanism to lock the tools in place and a tamper prevention mechanism to ensure the locking mechanism is not tampered with while the tool container is in the store.

### FIELD OF THE INVENTION

The present invention relates to the field of hand held tools. More specifically, the present invention relates to the field of T-handle tools and related safety, comfort, and convenience of accessories and tools.

### BACKGROUND OF THE INVENTION

T-handle tools have a T-shaped body, including a long leg member and a short handle member. T-handles usually have hexagonal-shaped tips for use with screws and other objects designed to accept a hexagonal tip. Once inserted, rotational pressure is applied to the hexagonal wrench in order to tighten or loosen the screw. The leg member and handle of the hexagonal wrench are designed to be in the shape of the letter “T” so that a user is able to grasp the handle with his hand more comfortably.

T-handle tools are manufactured and distributed in multiple English and metric sizes in order to facilitate their use with screw heads of multiple sizes. Such tools are usually sold in a set which includes tools of multiple sizes but are also distributed individually.

When using a T-handle tool, a user will insert a leg end of the T-handle tool into the head of a workpiece such as a screw, and will then exert rotational pressure using the handle on the handle end of the tool in order to tighten or loosen the screw. Due to the shape of the T-handle tool it is particularly difficult to quickly turn a T-handle tool because the user must constantly remove and replace his hand on the handle as it turns. Furthermore, the handle is usually not very easy to grip.

### SUMMARY OF THE INVENTION

A tool handle includes a cavity to receive a T-handle tool. When the tool handle is placed on the T-handle tool, the tool handle provides a better grip of the tool handle to apply greater torque. The tool handle includes a protrusion which is able to detachably couple with the T-handle tool. Once coupled with the T-handle tool, the tool handle is able to be grasped by a user to rapidly turn the T-handle tool. In some embodiments, the T-handle tool includes an added tool. A tool container is able to store T-handle tools and the tool handle. The tool container includes a locking mechanism to lock the tools in place and a tamper prevention mechanism to ensure the locking mechanism is not tampered with while the tool container is in the store.

In one aspect of the present invention, a tool handle comprises a tool handle body and a protruding member extending from the tool handle body, the protruding member configured to be inserted into a T-handle tool. The tool handle body farther comprises a cavity for the tool handle to detachably couple with the T-handle tool. The T-handle tool contains a receiving aperture for receiving the protruding member. In some embodiments, the protruding member is rounded and the receiving aperture is rounded to enable rotating of the T-handle tool. The tool handle body is longer and wider than the T-handle tool to enable better gripping of the T-handle tool. The tool handle body is configured to be positioned lengthwise vertically for rotating the T-handle tool. The T-handle tool further comprises a leg member and an arm member.

In another aspect of the present invention, a tool system comprises a T-handle tool and a tool handle further comprising a tool handle body and a protruding member extending from the tool handle body, the protruding member configured to be inserted into the T-handle tool. The tool handle body further comprises a cavity for the tool handle to detachably couple with the T-handle tool. The T-handle tool contains a receiving aperture for receiving the protruding member. In some embodiments, the protruding member is rounded and the receiving aperture is rounded to enable rotating of the T-handle tool. The tool handle body is longer and wider than the T-handle tool to enable better gripping of the T-handle tool. The tool handle body is configured to be positioned lengthwise vertically for rotating the T-handle tool. The T-handle tool further comprises a leg member and an arm member.

In yet another aspect of the present invention, a T-handle tool comprises a T-handle tool body and a receiving aperture contained within the T-handle tool body, the receiving aperture for receiving a protruding member of a tool handle. The tool handle further comprises a tool handle body which contains a cavity for the tool handle to detachably couple with the T-handle tool. The protruding member is rounded and the receiving aperture is rounded to enable rotating of the T-handle tool. The tool handle body is longer and wider than the T-handle tool to enable better gripping of the T-handle tool. The tool handle body is configured to be positioned lengthwise vertically for rotating the T-handle tool. The 1-handle tool further comprises a leg member and an arm member. The T-handle tool further comprises a rotating collar for stabilizing the T-handle tool body when the T-handle tool body is rotating.

In still yet another aspect of the present invention, a T-handle tool container comprises a tool container body configured to hold a group of one or more T-handle tools of multiple sizes securely upon insertion and a locking mechanism configured to lock the group of one or more T-handle tools within the tool container body.

In another aspect of the present invention, a method of storing a group of one or more T-handle tools securely, comprises inserting the group of one or more T-handle tools into a tool container, locking the group of one or more T-handle tools into the tool container with a locking mechanism and securing the locking mechanism in a locked position with a tamper prevention mechanism.

In yet another aspect of the present invention, a tool set comprises a group of one or more T-handle tools, a tool handle configured for detachably coupling with each of T-handle tools in the group of one or more T-handle tools and a tool container for storing the tool handle and the group of one or more T-handle tools.

### BRIEF DESCRIPTION OF THE DRAWINGS

FIG. 1A illustrates a perspective view of a tool handle.

FIG. 1B illustrates a perspective view of a modified tool handle.

FIG. 2A illustrates a perspective view of a T-handle tool.

FIG. 2B illustrates a perspective view of a modified T-handle tool.

FIG. 3A illustrates a perspective view of a tool handle detachably coupled with a T-handle tool.

FIG. 3B illustrates a perspective view of a tool handle positioned to rotate the T-handle tool.

FIG. 4A illustrates a front side view of a tool container for storing a group of one or more T-handle tools.

FIG. 4B illustrates a back view of a tool container for storing a group of one or more T-handle tools.

FIG. 4C illustrates a view of part of a tool container for storing a group of one or more T-handle tools.

FIG. 4D illustrates a close-up view of part of a tool container for storing a group of one or more T-handle tools.

FIG. 4E illustrates a front side view of a tool container for storing a group of one or more T-handle tools.

FIG. 5 illustrates a flowchart of a method of securing a group of one or more tools in a tool container.

### DETAILED DESCRIPTION OF THE PREFERRED EMBODIMENT

A tool handle aids a user in gripping a T-handle tool and includes a protrusion for inserting into the T-handle tool to then rotate the T-handle tool. A T-handle tool includes a handle component, a rotating collar and a leg which includes a tool such as a hexagonal wrench end. A modified T-handle tool includes an arm to include an added tool such as another hexagonal wrench. A tool container stores the T-handle tools. In some embodiments, the tool container includes a locking mechanism for locking the tools in place. In some embodiments, the tool container also includes a tamper prevention mechanism for preventing the locking mechanism from being tampered with.

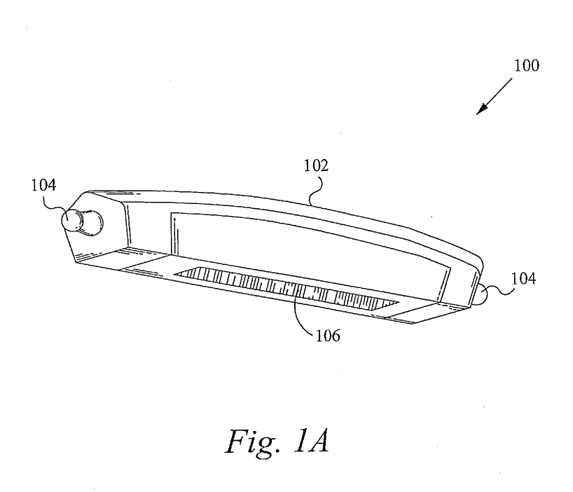

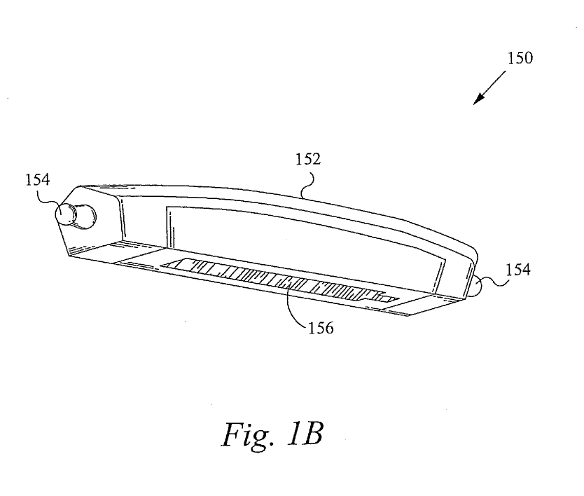

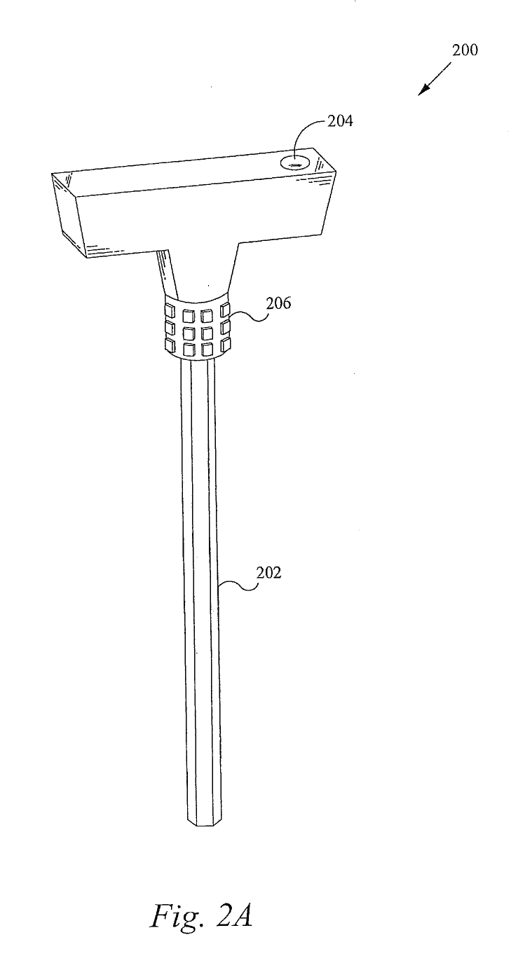

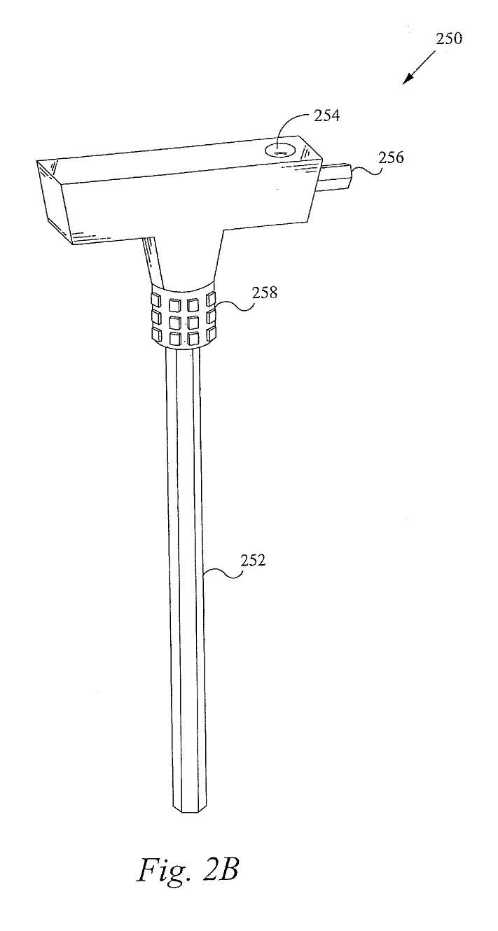

FIG. 1A illustrates a perspective view of a tool handle 100. The tool handle 100 includes a tool handle body 102, one or more protruding members 104 and a cavity 106. The tool handle body 102 comprises any material, including but not limited to, rubber, metal, wood and plastic. The tool handle body 102 is large enough to fit around a T-handle tool but not too large for a user to grasp comfortably. Specifically, in some embodiments, the tool handle body 102 is slightly longer and wider than the handle of the T-handle tool. In some embodiments, the tool handle body 102 is substantially rectangular. In some embodiments, the protruding members 104 extend from the tool handle body 102 at opposing ends. The protruding members 104 comprise any material, including but not limited to, rubber, metal, wood and plastic. In some embodiments, the protruding members 104 are rounded. The cavity 106 is shaped and sized to receive a T-handle tool 200 (FIG. 2A) so that the tool handle 100 is detachably coupled with the T-handle tool 200 (FIG. 2A).

FIG. 1B illustrates a perspective view of a modified tool handle 150. The tool handle 150 includes a tool handle body 152, one or more protruding members 154 and a cavity 156. The tool handle body 152 comprises any material, including but not limited to, rubber, metal, wood and plastic. The tool handle body 152 is large enough to fit around a T-handle tool but not too large for a user to grasp comfortably. Specifically, in some embodiments, the tool handle body 152 is slightly longer and wider than the handle of the T-handle tool. In some embodiments, the tool handle body 152 is substantially rectangular. In some embodiments, the protruding members 154 extend from the tool handle body 152 at opposing ends. The protruding members 154 comprise any material, including but not limited to, rubber, metal, wood and plastic. In some embodiments, the protruding members 154 are rounded. The cavity 156 is shaped and sized to receive a modified T-handle tool 250 (FIG. 2B) so that the tool handle 150 is detachably coupled with the modified T-handle tool 250 (FIG. 2B).

FIG. 2A illustrates a perspective view of a T-handle tool 200. The T-handle tool 200 includes a T-handle tool body 202 and a receiving aperture 204. The T-handle tool body 202 further includes a handle component and a leg component. A rotating collar 206 near the base of the handle component allows a user to stabilize the tool while turning the handle component. The rotating collar 206 is held in place by the user while the handle is turned. In some embodiments, the rotating collar 206 has ridges or small grooves. In some embodiments, the receiving aperture 204 is rounded. In some embodiments, the receiving aperture 204 is located on the top and near an end of the handle component of the T-handle tool body 202. In some embodiments, there are two or more receiving apertures 204, one at each end of the handle component. In some embodiments, the leg component includes a hexagonally-shaped head. The receiving aperture 204 is configured to receive a protruding member 104 (FIG. 1) of the tool handle 100 (FIG. 1).

FIG. 2B illustrates a perspective view of a modified T-handle tool 250. The T-handle tool 250 includes a T-handle tool body 252, a receiving aperture 254 and an arm 256. The T-handle tool body 252 further includes a handle component and a leg component. A rotating collar 258 near the base of the handle component allows a user to stabilize the tool while turning the handle component. The rotating collar 258 is held in place by the user while the handle is turned. In some embodiments, the rotating collar 258 has ridges or small grooves. In some embodiments, the receiving aperture 254 is rounded. In some embodiments, the receiving aperture 254 is located on the top and near an end of the handle component of the T-handle tool body 252. In some embodiments, there are two receiving apertures 254 or more, one at each end of the handle component. In some embodiments, the leg component includes a hexagonally-shaped head. The receiving aperture 254 is configured to receive a protruding member 104 (FIG. 1) of the tool handle 100 (FIG. 1). In some embodiments, the arm 256 extends out from the handle component of the T-handle tool 200. In some embodiments, the arm 256 includes a hexagonally-shaped end.

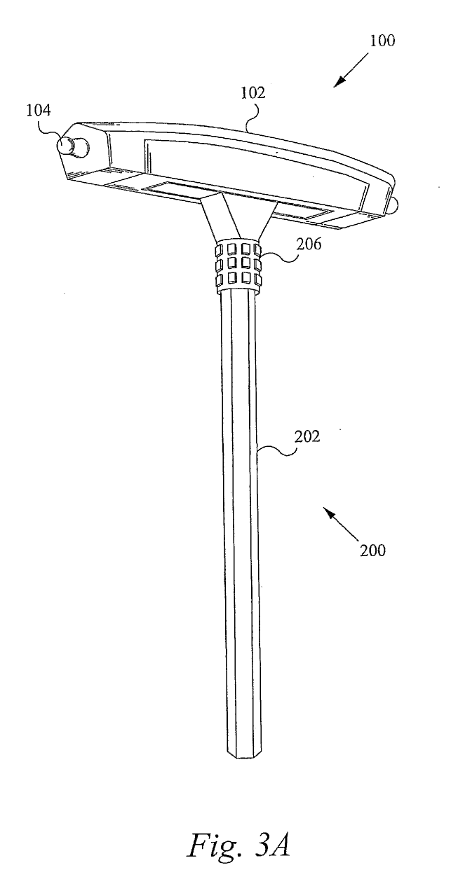

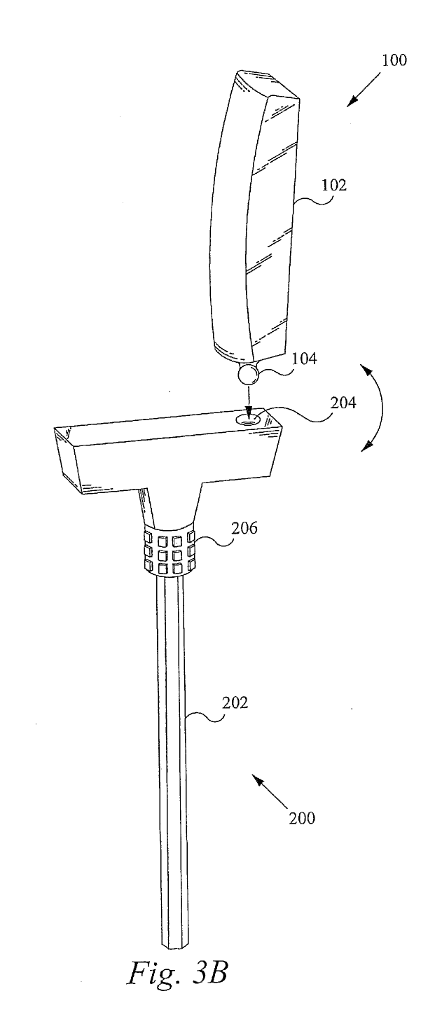

FIG. 3A illustrates a perspective view of a tool handle 100 detachably coupled with a T-handle tool 200. Specifically, the handle component of the T-handle tool body 202 is positioned within the cavity 106 (FIG. 1) of the tool handle body 102. When the T-handle tool body 202 is positioned within the cavity 106 (FIG. 1) of the tool handle body 102, a user has a larger handle to grip, thus making the T-handle tool 200 easier to grip and enabling the user to apply more torque with the T-handle tool 200. The user is also able to stabilize the T-handle tool 200 by holding a rotating collar 206.

FIG. 3B illustrates a perspective view of a tool handle 100 positioned to rotate the T-handle tool 200. With the tool handle body 102 positioned lengthwise in the same direction as the plane of the T-handle tool body 202, the protruding member 104 is able to be positioned in the receiving aperture 204 of the T-handle tool 200. A user is then able to move the tool handle 100 in a circular motion which causes the T-handle tool 200 to rotate. By using the protruding member 104 and the aperture 204, the user does not have to keep removing his hand after every rotation of the T-handle tool 200. Furthermore, it is possible to move the tool handle 100 in a circular motion much faster than simply turning one's hands. Therefore, using the T-handle tool 200 with the tool handle 100 in this position, a user is able to much more rapidly rotate the T-handle tool 200 which is likely being used to install or remove a screw or another object. The user is also able to stabilize the T-handle tool 200 by holding a rotating collar 206.

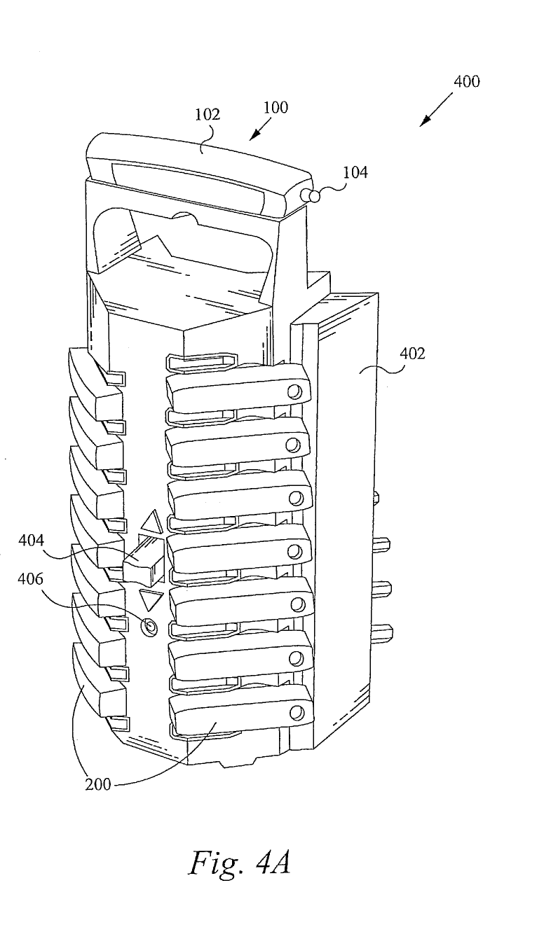

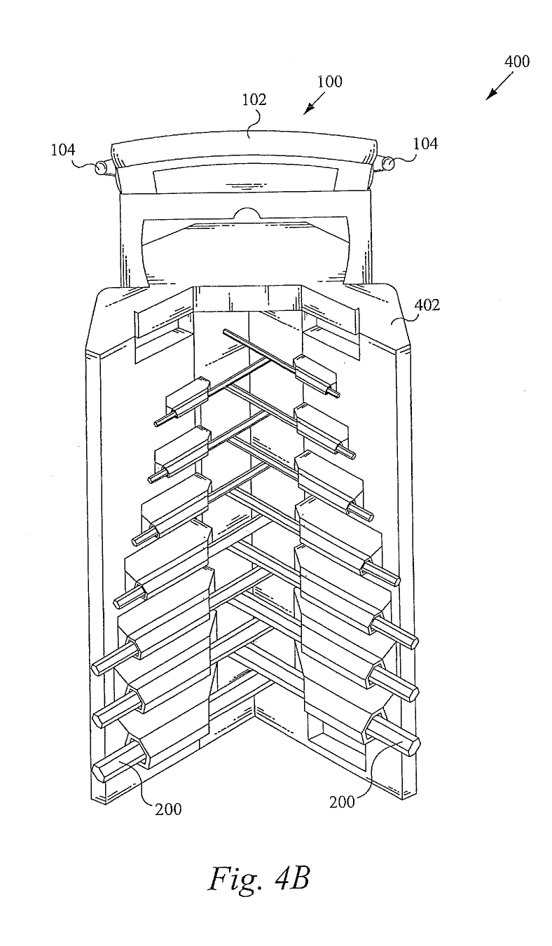

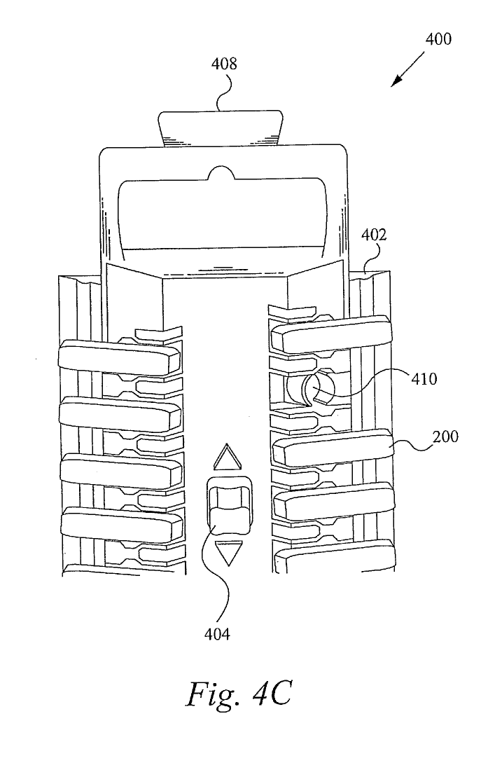

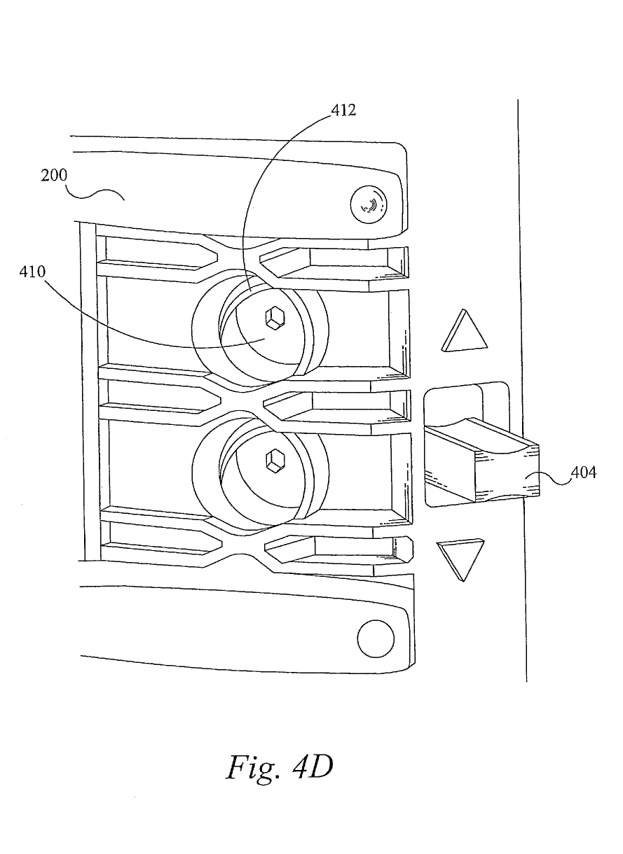

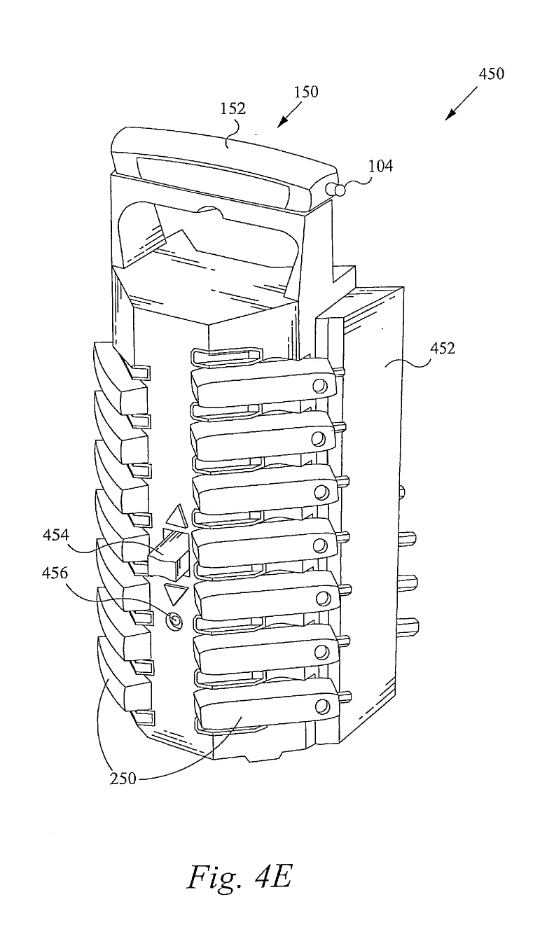

FIG. 4A illustrates a front side view of a tool container 400 for storing a group of one or more T-handle tools 200. The tool container 400 includes a tool container body 402 with receiving slots/apertures 410 (FIG. 4C) for receiving each of the T-handle tools 200. In some embodiments, there are other means for receiving each of the T-handle tools 200. In some embodiments, the receiving slots 410 (FIG. 4C) are configured in columns with one column for storing Standard American Equivalent-sized tools and the second column for storing metric-sized tools. The tool container 400 also includes a receiving member 408 (FIG. 4C) for receiving a tool handle 100. A handle of the tool container 400 is configured to allow the tool container 400 to be hung in a store for display. A locking mechanism 404 is included within the tool container 400 to lock the tools 200 within the tool container 400. The locking mechanism 404 includes a tab which is able to be toggled between a lock and an unlock position. The locking mechanism 404 also includes a plate 412 (FIG. 4D) that is movable into locked and unlocked positions, where in the locked position, the plate 412 (FIG. 4D) applies pressure on the rotating collar of the T-handle tools, so that they are not removable. When the tools 200 are locked in place, they are unable to be removed or fall out from the tool container 400. A tamper prevention mechanism 406 is included within the tool container 400 to ensure the locking mechanism 404 is not tampered with. The tamper prevention mechanism 406 is any device which prevents the locking mechanism 404 from being moved such as a screw which secures the locking mechanism plate 412 (FIG. 4D) in place. For example, while a tool container is in a retail store to be sold, the locking mechanism is in the “lock” position, so that the tools are not able to be removed and stolen. To prevent someone from simply toggling the locking mechanism to the “unlock” position, the tamper prevention mechanism is used. With the tamper prevention mechanism in place, a would-be thief would have to bring a screwdriver, spend the time to remove the screw and then move the switch to the “unlock” position to steal a tool. Thus, the locking mechanism used in conjunction with the tamper prevention mechanism is sufficient to securely display the tool container and tools without having to worry about them being stolen. When the tools, the handle and the container are together they form a set.

FIG. 4B illustrates a back view of a tool container 400 for storing a group of one or more T-handle tools 200. As described, in some embodiments, the tools 200 are stored in two columns. To minimize the size of the tool container 400, the tools 200 are stored in a criss-cross configuration, in some embodiments.

FIG. 4C illustrates a view of part of a tool container 400 for storing a group of one or more T-handle tools 200. A receiving member 408 allows a tool handle 200 to be stored on the tool container 400. A receiving slot 410 is where a T-handle tool 200 is inserted to be stored in the tool container 400.

FIG. 4D illustrates a close-up view of part of a tool container 400 for storing a group of one or more T-handle tools 200. A locking mechanism plate 412 which is able to be part of a locking mechanism 404 locks the tools 200 in place by applying pressure against the rotating collar of the T-handle tool 200. The locking mechanism plate 412 is moved by moving a locking mechanism tab. The locking mechanism plate 412 moves against the rotating collar of each T-handle tool 200 and applies pressure against the rotating collar, when the locking mechanism 404 is in the “lock” position. When the locking mechanism 404 is in the “unlock” position, the locking mechanism plate 412 is moved away from the rotating collar of each T-handle tool 200 which relieves the pressure against the rotating collar, thus allowing the T-handle tool 200 to be removed. In some embodiments, the locking mechanism is implemented by other means.

FIG. 4E illustrates a front side view of a tool container 450 for storing a group of one or more T-handle tools 240. The tool container 450 includes a tool container body 452 with receiving slots/apertures 410 (FIG. 4C) for receiving each of the T-handle tools 250. In some embodiments, there are other means for receiving each of the T-handle tools 250. In some embodiments, the receiving slots 410 (FIG. 4C) are configured in columns with one column for storing Standard American Equivalent-sized tools and the second column for storing metric-sized tools. The tool container 450 also includes a receiving member 408 (FIG. 4C) for receiving a tool handle 150. In some embodiments, the receiving member is shaped more similarly to the aperture 156 (FIG. 1B). A handle of the tool container 450 is configured to allow the tool container 450 to be hung in a store for display. A locking mechanism 454 is included within the tool container 450 to lock the tools 250 within the tool container 450. The locking mechanism 454 includes a tab which is able to be toggled between a lock and an unlock position. The locking mechanism 454 also includes a plate that is movable into locked and unlocked positions, where in the locked position, the plate applies pressure on the rotating collar component of the T-handle tools, so that they are not removable. When the tools 250 are locked in place, they are unable to be removed or fall out from the tool container 450. A tamper prevention mechanism 456 is included within the tool container 450 to ensure the locking mechanism 454 is not tampered with. The tamper prevention mechanism 456 is any device which prevents the locking mechanism 454 from being moved such as a screw which secures the locking mechanism plate in place.

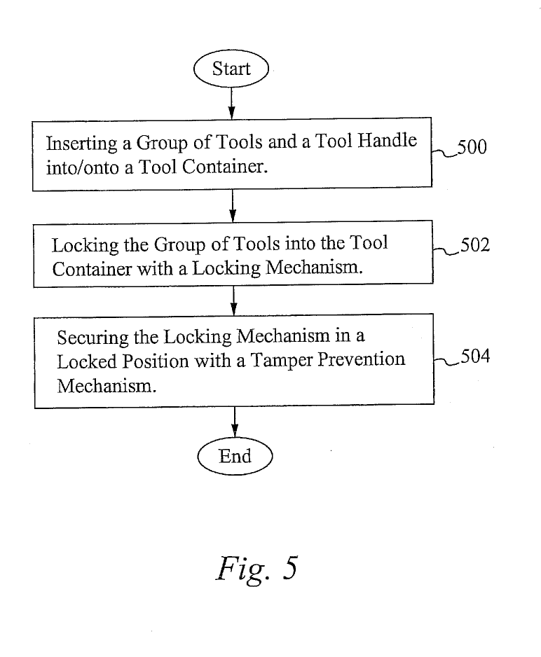

FIG. 5 illustrates a flowchart of a method of securing a group of one or more tools in a tool container 400. In the step 500, the group of one or more tools 200 is inserted into the tool container 400. In some embodiments, a set of metric tools are inserted into a first column of the tool container 400 and a set of standard tools are inserted into a second column of the tool container 400. In some embodiments, a tool handle 100 is also inserted onto the tool container 400. In the step 502, the group of one or more tools 200 is locked within the tool container 400 with a locking mechanism 404. The locking mechanism 404 is locked by moving a locking tab into a “lock” position. In the step 504, the locking mechanism is secured in a locked position with a tamper prevention mechanism 406. With the tool container 400 secured in a locked position, the tools are not removable. A same or similar method is used to store the modified tools 250 and the modified tool handle 150 in the tool container 450.

The tool handle is utilized by detachably coupling the tool handle and the T-handle tool, and grasping the tool handle and T-handle tool combination with one hand. Specifically, the T-handle tool is placed within the cavity of the tool handle. The tool handle is also utilized to more quickly rotate the T-handle tool by positioning the tool handle appropriately, inserting a protruding member of the tool handle into a receiving aperture of the T-handle tool and then moving the tool handle in a circular motion. The T-handle tool is still utilized as standard T-handle tool to insert or remove an object that is capable of receiving the T-handle tool.

To utilize the tool container one or more tools are inserted into the tool container. A tool handle is also able to be stored with the tool container. The tools are easily accessible in the tool container. Furthermore, while available for purchase, such as in a retail store, a locking mechanism and a tamper prevention mechanism ensure that no tools are stolen from the tool container. After or while the tool container is purchased, a user or a store employee removes the tamper prevention mechanism. Then, the user is able to remove, utilize and return the tools to the tool container as desired. The user is still able to lock the tools within the tool container to ensure the tools do not fall out. In some embodiments, the user is able to retain and reuse the tamper prevention mechanism to lock and ensure, for example, children are unable to access the tools.

In operation, the tool holder provides a larger grip for the T-handle tool. The tool holder is also able to act as a handle to rotate the T-handle tool similar to a hand crank.

In operation, the tool container includes a locking mechanism and a tamper prevention mechanism which are able to be used to allow the tool container and tools to be displayed yet protected from theft without the need for additional packaging. This removes the need for expensive added containment materials such as plastic that goes all around the tool container. Moreover, since the retaining mechanism utilizes less plastic, it is also more environmentally friendly. The tool container after purchase is also able to securely store the tool for easy access and use.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the appended claims.

1-21. (canceled)

22. A T-handle tool container comprising:
a. a tool container body configured to hold a group of one or more T-handle tools of multiple sizes securely upon insertion; and
b. a locking mechanism configured to lock the group of one or more T-handle tools within the tool container body.

23. A method of storing a group of one or more T-handle tools securely, comprising:
a. inserting the group of one or more T-handle tools into a tool container;
b. locking the group of one or more T-handle tools into the tool container with a locking mechanism; and
c. securing the locking mechanism in a locked position with a tamper prevention mechanism.

24. A tool set comprising:
a. a group of one or more T-handle tools;
b. a tool handle configured for detachably coupling with each of T-handle tools in the group of one or more T-handle tools; and
c. a tool container for storing the tool handle and the group of one or more T-handle tools.

25. The T-handle tool container of claim 22 wherein the tool container comprises one or more receiving slots for receiving the one or more T-handle tools.

26. The T-handle tool container of claim 25 wherein the one or more receiving slots are configured in columns.

27. The T-handle tool container of claim 22 wherein the tool container is configured to hold standard American sized tools or metric sized tools.

28. The T-handle tool container of claim 22 wherein the tool container comprises a receiving member for receiving a tool handle.

29. The T-handle tool container of claim 22 wherein the locking mechanism comprises a tab that is able to move between a lock position and an unlock position.

30. The T-handle tool container of claim 22 wherein the locking mechanism comprises an element movable between a locked position and a unlock position and that applies pressure to the one or more T-handle tools so they are not removable when the element is in the locked position.

31. The T-handle tool container of claim 22 wherein the tool container comprises a tamper prevention mechanism that prevents the locking mechanism from moving to the unlock position.

32. The T-handle tool container of claim 22 wherein the tool container is configured to be hung on a display.

33. The T-handle tool container of claim 22 wherein the one or more T-handle tools are stored in a criss-cross configuration.

34. The method of claim 23 wherein the one or more T-handle tools are inserted into one or more receiving slots.

35. The method of claim 34 wherein the one or more receiving slots are configured in columns.

36. The method of claim 23 wherein the tool container is configured to hold standard American sized tools or metric sized tools.

37. The method of claim 23 wherein the tool container comprises a receiving member for receiving a tool handle.

38. The method of claim 23 wherein the locking mechanism comprises a tab that is able to move between a lock position and an unlock position.

39. The method of claim 23 wherein the locking mechanism comprises an element movable between a locked position and a unlock position and that applies pressure to the one or more T-handle tools so they are not removable when the element is in the locked position.

40. The method of claim 23 wherein the one or more T-handle tools are stored in a criss-cross configuration.

41. A tool system comprising:
a. a tool comprising a receiving aperture offset from a center of the tool;
b. a tool handle comprising a protruding member for removably coupling with the receiving aperture.

42. The tool system of claim 41 wherein the tool handle comprises a cavity for the tool handle to detachably couple with the tool.

43. The tool system of claim 41 wherein the protruding member is rounded and the receiving aperture is rounded to enable rotating of the tool.

44. The tool system of claim 41 wherein the tool handle comprises a T-handle tool with a body that is longer and wider than the T-handle tool to enable better gripping of the T-handle tool.

45. The tool system of claim 44 wherein the T-handle tool further comprises a leg member and an arm member.

46. The tool system of claim 41 wherein the tool handle is configured to be positioned lengthwise vertically for rotating the tool.

47. A tool handle comprising:
a. a tool handle body;
b. a protruding member extending from a side of the body; and
c. a cavity on a top side or a bottom side of the tool handle body.

48. A tool comprising:
a. a body comprising a leg member for engaging a workpiece; and
b. a receiving aperture offset from a center of the body.

49. The tool of claim 48 wherein the receiving aperture is on an opposite side from the leg member.
